(19) United States
(12) Patent Application Publication
(10) Pub. No.: US 2007/0114095 A1
(43) Pub. Date: May 24, 2007

(54) Positioning and safety lanyard device and associated method of use

(76) Inventors: Thomas Joseph Swierski, Matthews, NC (US); Robert John Swierski, Matthews, NC (US)

Correspondence Address: CLEMENTS WALKER, 1901 ROXBOROUGH ROAD, SUITE 300, CHARLOTTE, NC, 28211, US

(21) Appl. No.: 11/601,391

(22) Filed: Nov. 17, 2006

Related U.S. Application Data
(60) Provisional application No. 60/738,137, filed on Nov. 18, 2005.

(51) Int. Cl. A62B 35/00

(52) U.S. Cl. 182/9

(57) ABSTRACT

The present invention provides a positioning and safety lanyard device, for use in the prevention of falls from an elevated height, comprised of: two loops or substantially looped portions, a fixed loop and an adjustable loop, the adjustable loop having a pull side with which to either, while the wire positioning and safety lanyard device is in use, shorten or lengthen the adjustable loop depending on the direction of pull; crimped, no-slide wire holders or the like; slidable wire holders or the like; a knot configuration with which the fixed loop and the adjustable loop are adjoined; and spring-loaded clasps or the like at each end of the positioning and safety lanyard device.

### CROSS-REFERENCE TO RELATED APPLICATION(S)

The present non-provisional patent application claims the benefit of priority of U.S. Provisional Patent Application No. 60/738,137, which is entitled “Wire Lanyard for Climbing Columns”, which was filed on Nov. 18, 2005, and which is incorporated in full by reference herein.

### FIELD OF THE INVENTION

The present invention relates generally to the field of fall prevention positioning and safety devices for climbing structural support columns, utility poles, trees, and the like. More specifically, the present invention relates to a positioning and safety lanyard device comprised of: two loops or substantially looped portions, a fixed loop or substantially looped portion and an adjustable loop or substantially looped portion, the adjustable loop having pull/push sides with which, while the positioning and safety lanyard device is in use, to either shorten or lengthen the adjustable loop, and resultantly the positioning and safety lanyard device, depending on the direction of pull/push; crimped, no-slide wire holders or the like; slidable wire holders or the like; a knot configuration, with which the fixed loop and the adjustable loop are adjoined; and clasps or the like at each end of the positioning and safety lanyard device.

### BACKGROUND OF THE INVENTION

There is a need to protect a worker who is engaged in work at an elevated position from falling. To protect such a worker from a dangerous fall is not only common sensical, but also is required to comply with various laws regarding occupational safety for those working at elevated positions. For example, workers on steel construction support beams or columns, such as an I-beam or I-column, utility pole workers, tree climbers, and the like, should all be protected against an injurious, or perhaps even fatal, fall. Additionally, many occupational safety laws pertaining to such circumstances require a positioning and safety device be used by those working at an elevated position.

One method by which a worker can be safely secured at a high elevation and protected from a dangerous or fatal fall involves the use of a safety belt or a safety harness. Such belts or harnesses usually include at least one D-ring, a solid metal loop permanently mounted on the outer edge of the belt or harness with which to securely attach a positioning and safety lanyard device.

Many positioning and safety lanyard devices used to connect to a safety belt, safety harness, or the like are well known to those of ordinary skill in the art. For example, there are fall arrest belt assemblies, safety slings, lanyards with pole-gripping means, lineman's safety straps, safety belts for climbing tree stands, and various other fall prevention devices. While these lanyard and other related devices are generally suitable for their intended purpose, that of keeping a worker at an elevated height from falling, they do have their disadvantages.

Many positioning and safety lanyard devices are not adjustable. While some positioning and safety lanyard devices are not adjustable by any means, others are simply not easily or safely adjustable while they are in use by a worker at an elevated height. Those positioning and safety lanyard devices in existence that are not adjustable leave a worker with only the industry standard sizes from which to choose. Common industry standard sizes for lanyards are four feet, six feet, and eight feet in length. These standard sizes may not adequately provide the worker with the safest length of lanyard to safely secure the worker at an elevated location. A positioning and safety lanyard device is needed that a worker can easily and safely adjust while the device is being used.

Still other positioning and safety lanyard devices exist that bind while in use. Once binding begins, the positioning and safety lanyard device straps or wires are restricted in such a way that they start to stick or even become stuck. Such binding prevents those lanyards that are supposed to be adjustable from being easily adjusted, further compromising both convenience and safety. Additionally, the binding creates additional friction complicating ease of use.

Additionally, many positioning and safety lanyard devices are comprised of a strap or straps of nylon or other fabric material used in combination with a strap buckle. Such nylon or other fabric material tends to fray over time and use, especially when in contact with steel support structures and/or the like. Such fraying can hamper ease of use and safety, ultimately creating an unsafe device.

These and other problems exist. Previous attempts to solve these and other problems include the following:

U.S. Pat. No. 4,159,044, issued to Wydra on Jun. 26, 1979, discloses a safety working lanyard which interconnects with a D-ring on a safety belt to provide a safety line that is versatile and readily adjustable in length while in use. End hooks connectable to the D-ring are secured to each end of a length of safety line, and a working hook has an eye that is freely slideable along the length of the line and is also trapped between the end hooks. The end hooks are sized to pass through the D-ring on the belt and connect to the working hook, which is too large to pass through the D-ring and large enough to hook onto a ladder rung.

U.S. Pat. No. 5,234,074 issued to Bell on Aug. 10, 1993, discloses a fall arrest lanyard for use by a worker at an elevated position on a pole, e.g., a telephone pole. The lanyard comprises a flexible strap and a pair of gripping units. The strap is arranged to be releasably connected to the worker to form a loop encircling the pole. Each of the gripping units comprises an elongated, arcuate tubular member having a handgrip at one end and pole penetrating members at the other end. The strap extends through both tubular members. The penetrating members are made up of an enlarged head having a plurality of larger upper teeth and a plurality of small lower teeth. Each tooth has a horizontally disposed cutting edge. The gripping units are arranged to be manipulated by the worker grasping the handgrips to cause the cutting edges of all of the teeth to penetrate into the material of the pole.

U.S. Pat. No. 5,287,943 issued to Bell on Feb. 22, 1994, discloses a lanyard for connection to safety device, e.g., a belt or harness, worn by a worker and for connection to an anchor point. The lanyard is arranged to be used in a method to prevent the worker from falling. The lanyard comprises a flexible member, e.g., nylon or polyester webbing, having first, second, and third, elongated sections, each of the sections having a first end and a second end. The second ends of all of the sections are connected, e.g., sewn, to one another. Each of the first ends of the lanyard includes a respective connector, e.g., a clasp, mounted thereon. In accordance with the method of use the connector of the first section is releasably secured to the safety device, while the connectors of the second and third sections are releasably secured to the anchor point. A shock absorber may be included in the first section of the lanyard.

U.S. Pat. No. 5,165,499 issued to Bell on Nov. 24, 1992, discloses an anchor system for use with a lanyard secured to a worker located at an elevated position to prevent the worker from falling. The anchor system is arranged to be releasably secured to a fixed member, e.g., an I-beam, adjacent the elevated position and comprises a releasable holding assembly and an associated connector assembly. The holding assembly comprises an elongated flexible strap and a releasable fastening/locking device. The releasable fastening/locking device is a ratchet-operated member fixedly secured to one end portion of the strap for receiving the other end portion of the strap so that the strap can be tightly encircled about a portion of the fixed member against accidental slippage or disconnection. The connector assembly comprises a sleeve having a ring fixedly mounted thereon. The sleeve is arranged to receive the strap therethrough to mount it on the strap at any desired position. The lanyard is connected to the anchor assembly via the ring.

U.S. Pat. No. 4,298,091 issued to Anderson on Nov. 3, 1981, discloses a harness which may be used as a sling to suspend a person from a support in either a sitting or standing position, or may be placed on the shoulder to exert force on a load includes a closed loop of webbing material which is loosely slidable through a pair of D-rings, and a double length of rope, one end of each length being connected to one of the rings with the other ends being provided with a snap-hook arrangement for encircling a support or for attachment to a load. A slider on the double rope can be moved to adjust the overall size of the sling and the webbing is held by the rings in the form of two supporting loops which adjust to the body size.

U.S. Pat. No. 2,920,714, issued to Johnson on Jan. 12, 1960, discloses a safety device adapted to be used by linemen or other climbers for climbing poles or trees and for keeping workmen from falling from a pole.

U.S. Pat. No. 4,579,196 issued to Allen et al. on Apr. 1, 1986, discloses a lineman's safety strap comprises an outer strap connected to the lineman's body belt and extending around the outer face of a pole to be climbed, and an inner strap extending between end portions of the outer strap across the inner face of the pole. The outer strap has inwardly and downwardly directed teeth which, in the event of a fall, bite into the pole, the inner strap bearing against the opposite face of the pole and cooperating with the toothed outer strap to support the lineman.

While these patents and other previous devices and methods have attempted to solve the above mentioned problems, none have utilized a wire positioning and safety lanyard as disclosed in the present invention with its unique knot configuration, closed wire loop, and adjustable wire loop that together allow for shortening or lengthening the positioning and safety lanyard while it is in use. Furthermore, none of the patents in the prior art discloses a positioning and safety lanyard device that does not bind or fray while in use or after extended use.

Therefore, a need exists for a wire positioning and safety lanyard device comprising two wire loops and a knot configuration that allows for length adjustments of the positioning and safety lanyard device, either shortening or lengthening it depending on the direction of pull/push, while it is in use by a worker at an elevated height.

### BRIEF SUMMARY OF THE INVENTION

In various embodiments, the present invention provides a positioning and safety lanyard device for climbing structural support columns, utility poles, trees, and the like.

In one exemplary embodiment of the present invention, a wire positioning and safety lanyard device is disclosed. The wire positioning and safety lanyard device is comprised of: two wire loops or substantially looped portions, a fixed wire loop or substantially looped portion and an adjustable wire loop or substantially looped portion, the adjustable wire loop having pull/push sides with which, while the wire positioning and safety lanyard device is in use, to either shorten or lengthen the adjustable wire loop depending on the direction of pull/push; crimped, no-slide wire holders or the like; slidable wire holders or the like; a knot configuration with which the fixed wire loop and the adjustable wire loop are adjoined; and clasps or the like at each end of the wire positioning and safety lanyard.

The fixed wire loop or substantially looped portion is comprised of a short piece of wire. The wire comprising the fixed wire loop may be, but is not limited to, steel cable. Additionally, the steel cable may be vinyl coated for anti-corrosive value. At one end, the wire comprising the fixed wire loop is securely attached through the hole of a spring-loaded clasp or the like and securely fastened to itself with a crimped, no-slide wire holder or the like. At the other end, the wire comprising the fixed wire loop is longer and the fixed wire loop itself composes one half of the knot configuration used in the positioning and safety lanyard device. The wire comprising the fixed wire loop is of a substantially shorter length than the wire comprising the adjustable wire loop. Additionally, and optionally, the wire comprising the fixed wire loop is of one continuous piece. It should be noted that it is preferred that both loops are of the same material and same basic diameter or size, in order to increase gripping.

The adjustable wire loop or substantially looped portion is comprised of a long piece of wire. The wire comprising the adjustable wire loop also may be, but is not limited to, steel cable. Additionally, the steel cable may be vinyl coated for additional safety and aesthetic value. At one end, the wire comprising the adjustable wire loop is securely attached through the hole of a spring-loaded clasp or the like and securely fastened to itself with a crimped, no-slide wire holder or the like. At the other end, the wire comprising the adjustable wire loop is longer and the adjustable wire loop itself composes one half of the knot configuration used in the wire positioning and safety lanyard device. Optionally, the wire comprising the adjustable wire loop is not of one continuous piece as is the wire comprising the fixed wire loop. This results in end pieces of the wire comprising the adjustable wire loop. Such a wire end is held into place by the use of a slidable wire holder or the like. The slidable wire holder does not crimp down on a portion of the wire, nor does it prevent movement of a portion of the wire. It is merely a holder, in one potential embodiment of the present invention. The adjustable wire loop is further comprised of pull/push sides with which, while the wire positioning and safety lanyard is in use, a worker can either shorten or lengthen the adjustable wire loop, and resultantly the wire positioning and safety lanyard device, depending on the direction of pull/push. The side opposite the adjustable wire, pull side is the adjustable wire, push side. This side moves through the knot configuration as a worker pulls on the adjustable wire, pull side, but it is not meant to be the side of the knot configuration that is pulled to either shorten or lengthen the wire positioning and safety lanyard. Optionally, the adjustable wire loop also is substantially longer than the fixed wire loop.

Although the fixed wire loop and adjustable wire loop are comprised of wire or steel cable, other materials such as, but not limited to, one-half inch minimum diameter or width nylon rope, Kevlar® fabric, woven polyester, or any similar material that is strong, abrasion-resistant, and lightweight may be used. Additionally, a rope material, such as that used by rock climbers, may be used in an alternative embodiment.

The slidable wire holder or the like is used along the path of the adjustable wire loop. The slidable wire holder provides containment for the wire on each side of the adjustable wire loop. The slidable wire holder does not crimp down on a portion of the wires, nor does it prevent movement of a portion of the wires.

The crimped, no-slide wire holder or the like is used at each end of the wire positioning and safety lanyard device near each spring-loaded clasp or the like. The crimped, no-slide wire holder or the like allows for no movement of the wires placed in it. It permanently locks those wires into place. It further provides for secure attachment to each spring-loaded clasp or the like.

The knot configuration is made from the combination of the fixed wire loop and the adjustable wire loop. The form of the knot configuration is generally that of a square knot or reef knot. The knot configuration is used to join two pieces of wire together, the fixed wire comprising the fixed wire loop and the wire comprising the adjustable wire loop. As such, the knot configuration allows for easy length adjustments of the wire positioning and safety lanyard device while it is in use, an objective of the present invention. Adjustment of the length of the positioning and safety lanyard device is accomplished by movement of the adjustable wire loop within the knot configuration. The adjustable wire loop is comprised of pull/push sides with which, while the wire positioning and safety lanyard device is in use, a worker can either shorten or lengthen the adjustable wire loop, and resultantly the wire positioning and safety lanyard device, depending on the direction of pull/push. The pressure on the adjustable wire loop within the knot configuration provided by the pull tension from the fixed wire loop keeps the adjustable wire loop from sliding out of the knot configuration altogether. While the wire positioning and safety lanyard device is in use, a constant tension is placed on the adjustable wire loop and the fixed wire loop of the knot configuration.

The spring-loaded clasp or the like is commonplace in the industry. The spring-loaded clasp or the like is a self-locking snap hook that easily attaches to a D-ring on a safety belt or safety harness. The spring-loaded clasp or the like includes a hole at one end that permits permanent connection to a wire loop or other device used in tethering. One spring-loaded clasp is connected at a hole permanently to the fixed wire comprising the fixed wire loop. Another spring-loaded clasp is connected at a hole permanently to the wire comprising the adjustable wire loop. For a worker wearing a safety belt with a D-ring on each side of the waist, the wire positioning and safety lanyard is wrapped around a structural support column, utility pole, tree, or the like, forming a generally horizontal loop, and the spring-loaded clasps at each end of the wire positioning and safety lanyard are then securely attached to each D-ring. The underside of the spring-loaded clasp is provided with a release button to enable the user the ability to unattach the wire positioning and safety lanyard from a safety belt or other connection point. The spring-loaded clasp could also optionally be attached to an anchor point on a structural support column or similar point for safely anchoring a worker to another object and providing fall prevention. Once a wire positioning and safety lanyard device is in use and the spring-loaded clasp at each end of the wire positioning and safety lanyard is locked into place, the worker is provided fall prevention.

Thus, together, all of these individually described components form one exemplary embodiment of a wire positioning and safety lanyard device: two wire loops or substantially looped portions, a fixed wire loop and an adjustable wire loop, the adjustable wire loop having pull/push sides with which, while the wire positioning and safety lanyard device is in use, to either shorten or lengthen the adjustable wire loop depending on the direction of pull/push; crimped, no-slide wire holders or the like; slidable wire holders or the like; a knot configuration with which the fixed wire loop and the adjustable wire loop are adjoined; and clasps or the like at each end of the wire positioning and safety lanyard.

In another exemplary embodiment of the present invention, the functionality of the fixed wire loop or substantially looped portion is provided by a spring-loaded clasp or the like. The adjustable wire loop is looped through the hole of the clasp or the like as if it were the loop of another wire. The resultant product is still an adjustable wire positioning and safety lanyard device.

In another exemplary embodiment of the present invention, an alternate configuration is used such that the fixed loop (whether wire or fabric) includes keeper loops. The keeper loops are securely and permanently affixed to the wire or fabric on which they are placed. The keeper loops serve as both a guide to hold the adjustable loop in place and to place additional tension in the knot configuration. The keeper loops keep the knot configuration from ever being to slack to keep the loops remaining together. The same purpose might also be solved by using a metal or plastic retaining clip that is permanently mounted to one loop and that provides an additional metal or plastic roughly three-quarter circumference cylindrical channel in which to place the second loop and hold it in place securely.

In another exemplary embodiment of the present invention, the wire positioning and safety lanyard device is further comprised of a knot configuration outer covering. The knot configuration outer covering serves as a sleeve for the knot configuration, thus providing additional protection to the wires comprising the fixed wire loop and the adjustable wire loop. Additionally, the knot configuration outer covering aids in keeping the wires comprising the fixed wire loop and the adjustable wire loop free from dirt or debris that may be commonplace at a job site. By keeping these components clean, the knot configuration outer covering also aids in the easy adjustability of the wire positioning and safety lanyard.

In yet another exemplary embodiment of the present invention, an alternate configuration is used such that the knot configuration is comprised of a sheath covering on the top and bottom of the knot configuration. The fixed wire loop and the adjustable wire loop are covered at the two points where they cross in the knot configuration.

A primary advantage of the present invention is that this wire positioning and safety lanyard overcomes an adjustability limitation found commonly in the prior art. While many positioning and safety lanyards are not adjustable or are limited in their adjustability, the present invention discloses a wire positioning and safety lanyard that is easily and safely adjustable. Additionally, this wire positioning and safety lanyard is adjustable while in use, providing a worker the ability to shorten or lengthen the wire positioning and safety lanyard while the device is in use and the worker is busy working at an elevated height.

Another advantage of the present invention is that the wire positioning and safety lanyard also overcomes a limitation found commonly in the prior art in regard to binding. While many positioning and safety lanyards in the prior art will bind and restrict movement of the device, this wire positioning and safety lanyard does not bind while in use. This key advantage provides the user of the wire positioning and safety lanyard with the added benefits of convenience and safety since no additional friction is created complicating ease of use for the worker.

Another advantage of the present invention is that the wire positioning and safety lanyard also overcomes the concern of fraying, a common issue amongst traditional positioning and safety lanyards. While many positioning and safety lanyards are comprised of a strap or straps of nylon or other fabric material used in combination with a strap buckle, this invention, in its preferred embodiment, uses the combination of two wire loops. Use of these wire loops in the wire positioning and safety lanyard prevents fraying and, therefore, provides for ease of use and safety.

### BRIEF DESCRIPTION OF THE DRAWINGS

The present invention is illustrated and described herein with reference to preferred embodiments and examples thereof, in which like reference numbers denote like parts or components, and in which:

FIG. 1 is a top planar view of a positioning and safety lanyard device for use according to an embodiment of the present invention;

FIG. 2 is a front planar view of a positioning and safety lanyard device for use according to an embodiment of the present invention;

FIG. 3 is a front planar view of a knot configuration for use according to an embodiment of the present invention;

FIG. 4 is a front planar view of a knot configuration for use according to an embodiment of the present invention;

FIG. 5 is a front planar view of a knot configuration for use according to an embodiment of the present invention;

FIG. 6 is a front planar view of a knot configuration for use according to an embodiment of the present invention; and

FIG. 7 is a series of photographs of a fabric or strap embodiment of the positioning and safety lanyard device of the present invention.

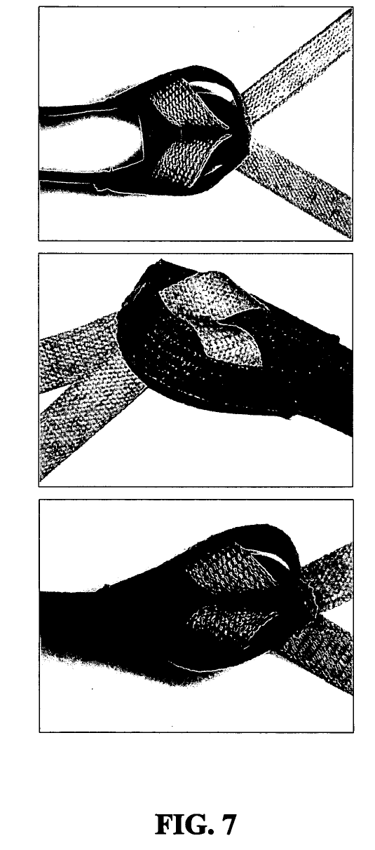

### DETAILED DESCRIPTION OF THE INVENTION

Before describing the disclosed embodiments of the present invention in detail, it is to be understood that the invention is not limited in its application to the details of the particular arrangement shown since the invention is capable of other embodiments. Also, the terminology used herein is for the purpose of description, and not of limitation.

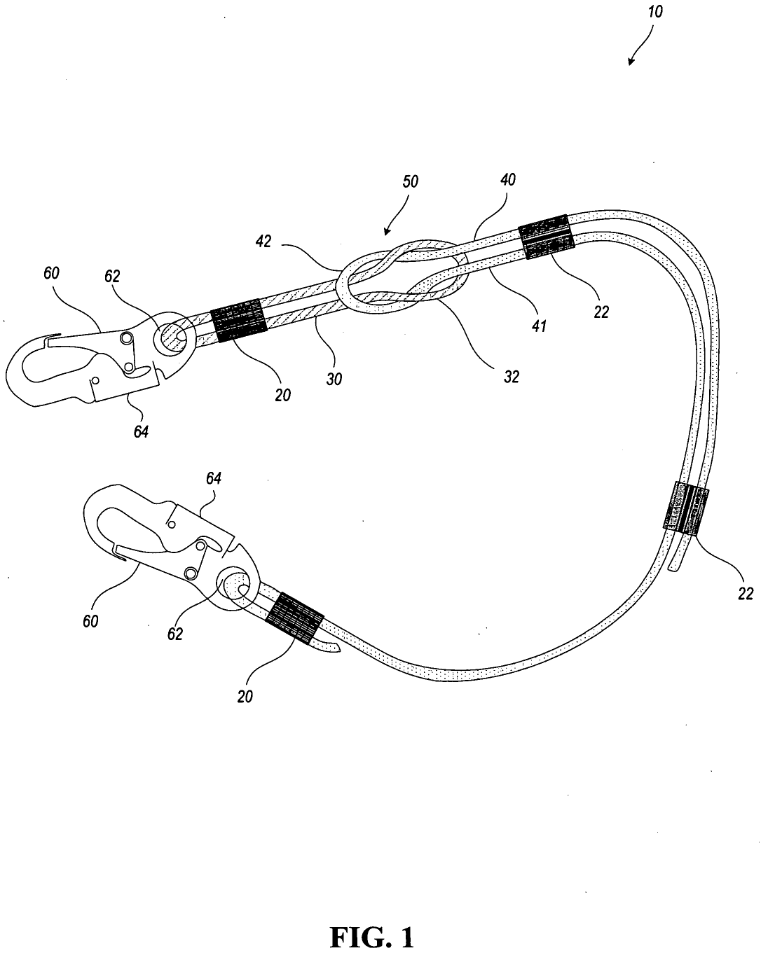

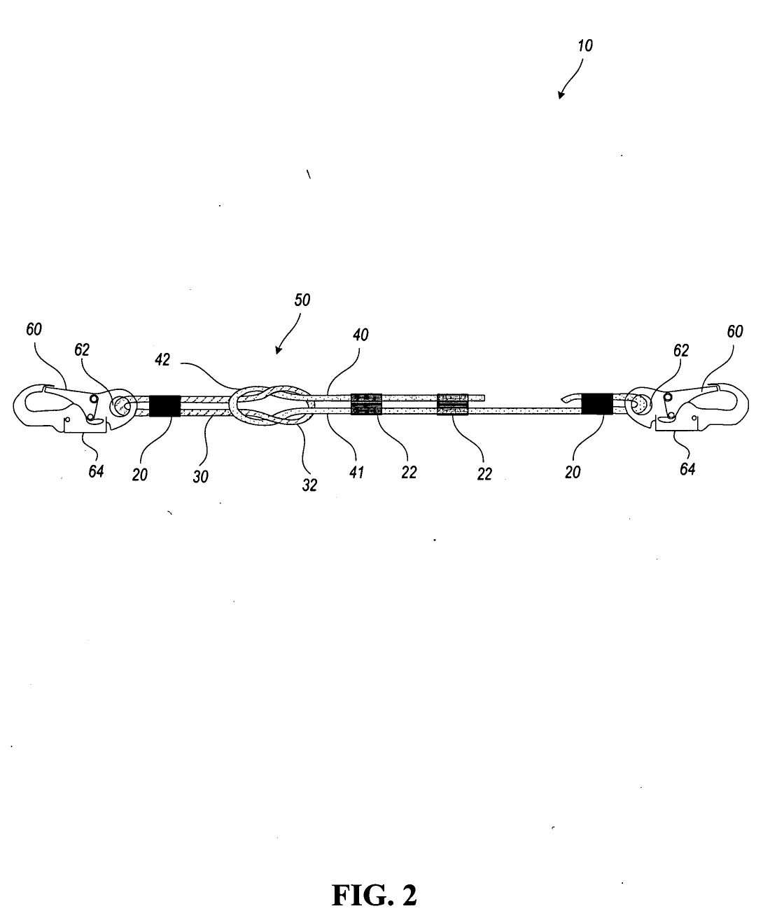

Referring now to FIGS. 1 and 2, a top planar view of a wire positioning and safety lanyard 10 and a front planar view of a wire positioning and safety lanyard 10, respectively, are shown. The wire positioning and safety lanyard 10 is comprised of: two wire loops, a fixed wire loop 32 and an adjustable wire loop 42, the adjustable wire loop 42 having a pull side 40 with which, while the wire positioning and safety lanyard 10 is in use, to either shorten or lengthen the adjustable wire loop 42 depending on the direction of pull; crimped, no-slide wire holders 20; slidable wire holders 22; a knot configuration 50 with which the fixed wire loop 32 and the adjustable wire loop 42 are adjoined; and clasps 60 at each end of the wire positioning and safety lanyard 10.

The fixed wire loop 32 is comprised of a short piece of wire. The fixed wire 30 comprising the fixed wire loop 32 may be, but is not limited to, steel cable. Additionally, the steel cable may be vinyl coated for anti-corrosive value. At one end, the fixed wire 30 comprising the fixed wire loop 32 is securely attached through the hole 62 of a spring-loaded clasp 60 and securely fastened to itself with a crimped, no-slide wire holder 20. At the other end, the fixed wire 30 comprising the fixed wire loop 32 is longer and the fixed wire loop 32 itself composes one half of the knot configuration 50 used in the wire positioning and safety lanyard 10. The fixed wire 30 comprising the fixed wire loop 32 is of a much shorter length than the wire comprising the adjustable wire loop 42. Additionally, the fixed wire 30 comprising the fixed wire loop 32 is of one continuous piece.

The adjustable wire loop 42 is comprised of a long piece or wire. The wire comprising the adjustable wire loop 42 also may be, but is not limited to, steel cable. Additionally, the steel cable may be vinyl coated for additional safety and aesthetic value. At one end, the wire comprising the adjustable wire loop 42 is securely attached through the hole 62 of a spring-loaded clasp 60 and securely fastened to itself with a crimped, no-slide wire holder 20. At the other end, the wire comprising the adjustable wire loop 42 is longer and the adjustable wire loop 42 itself composes one half of the knot configuration 50 used in the wire positioning and safety lanyard 10. The wire comprising the adjustable wire loop 42 is not of one continuous piece of wire as is the fixed wire 30 comprising the fixed wire loop 32. This results in exposed end pieces of the wire comprising the adjustable wire loop 42. Such a wire end is held into place by the use of a slidable wire holder 22. The slidable wire holder 22 does not crimp down on a portion of the wire, nor does it prevent movement of a portion of the wire. It is merely a holder. The adjustable wire loop 42 is further comprised of a pull side 40 with which, while the wire positioning and safety lanyard 10 is in use, a worker can either shorten or lengthen the adjustable wire loop 42, and resultantly the wire positioning and safety lanyard 10 as a whole, depending on the direction of pull. The side opposite the adjustable wire, pull side 40 is the adjustable wire, non-pull side 41. This adjustable wire, non-pull side 41 moves through the knot configuration 50 as a worker pulls on the adjustable wire, pull side 40, but it is not meant to be the side of the knot configuration 50 that is pulled to either shorten or lengthen the wire positioning and safety lanyard 10. The adjustable wire loop 42 also is much longer than the fixed wire loop 32.

Although the fixed wire loop 32 and adjustable wire loop 42 are comprised of wire or steel cable, the other materials such as one-half inch nylon rope, Kevlar® fabric, woven polyester, or any similar material that is very strong and lightweight may be used.

The slidable wire holder 22 is used along the path of the adjustable wire loop 42. The slidable wire holder 22 provides containment for the wire on each side of the adjustable wire loop 42. The slidable wire holder 22 does not crimp down on one of the wires, nor does it prevent movement of one of the wires.

The crimped, no-slide wire holder 20 is used at each end of the wire positioning and safety lanyard 10 near each spring-loaded clasp 60. The crimped, no-slide wire holder 20 allows for no movement of the wires placed in it. It permanently locks those wires into place. It further provides for secure attachment to each spring-loaded clasp 60.

The knot configuration 50 is made from the combination of the fixed wire loop 32 and the adjustable wire loop 42. The form of the knot configuration 50 is generally that of a square knot or reef knot. The knot configuration 50 is used to join two pieces of wire together, the fixed wire 30 comprising the fixed wire loop 32 and the wire comprising the adjustable wire loop 42. As such, the knot configuration 50 allows for easy length adjustments of the wire positioning and safety lanyard 10 while it is in use, an objective of the present invention. Adjustment of the length of the wire positioning and safety lanyard 10 is accomplished by movement of the adjustable wire loop 42 within the knot configuration 50. The adjustable wire loop 42 is comprised of a pull side 40 with which, while the wire positioning and safety lanyard 10 is in use, a worker can either shorten or lengthen the adjustable wire loop 42, and resultantly the wire positioning and safety lanyard 10, depending on the direction of pull. The pressure on the adjustable wire loop 42 within the knot configuration 50 provided by the pull tension from the fixed wire loop 32 keeps the adjustable wire loop 42 from sliding out of the knot configuration 50 altogether. While the wire positioning and safety lanyard 10 is in use, a constant tension is placed on the adjustable wire loop 42 and the fixed wire loop 32 of the knot configuration 50.

The spring-loaded clasp 60 is commonplace in the industry. The spring-loaded clasp 60 is a self-locking snap hook that easily attaches to a D-ring on a safety belt or safety harness. The spring-loaded clasp 60 includes a hole 62 at one end that permits permanent connection to a wire loop or other device used in tethering. One spring-loaded clasp 60 is connected at a hole 62 permanently to the fixed wire 30 comprising the fixed wire loop 32. Another spring-loaded clasp 60 is connected at a hole 62 permanently to the wire comprising the adjustable wire loop 42. For a worker wearing a safety belt with a D-ring on each side of the waist, the wire positioning and safety lanyard 10 is wrapped around a structural support column, utility pole, tree, or the like, forming a generally horizontal loop, and the spring-loaded clasp 60 at each end of the wire positioning and safety lanyard 10 then is securely attached to each D-ring. The underside of the spring-loaded clasp 60 is provided with a release button 64 to enable the user the ability to unattach the wire positioning and safety lanyard 10 from a safety belt or other connection point. The spring-loaded clasp 60 could also optionally be attached to an anchor point on a structural support column or similar point for safely anchoring a working to another object and providing fall prevention. Once a wire positioning and safety lanyard 10 is in use and the spring-loaded clasp 60 at each end of the wire positioning and safety lanyard 10 is locked into place, the worker is provided fall prevention.

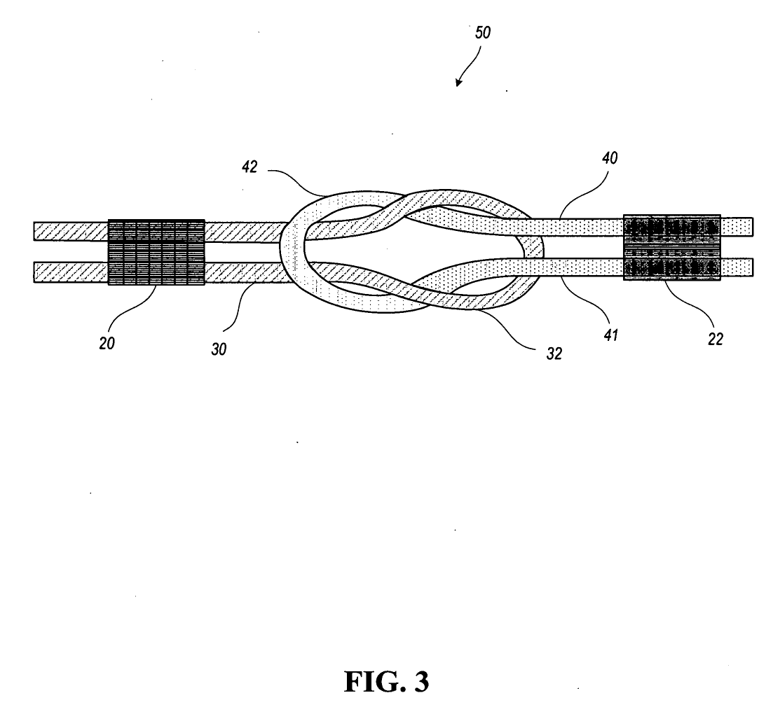

Referring now to FIG. 3, a front planar view of a knot configuration 50 is shown. The knot configuration 50 is made from the combination of the fixed wire loop 32 and the adjustable wire loop 42. The form of the knot configuration 50 is generally that of a square knot or reef knot. The knot configuration 50 is used to join two pieces of wire together, the fixed wire 30 comprising the fixed wire loop 32 and the wire comprising the adjustable wire loop 42. As such, the knot configuration 50 allows for easy length adjustments of the wire positioning and safety lanyard 10 while it is in use, an objective of the present invention. Adjustment of the length of the wire positioning and safety lanyard 10 is accomplished by movement of the adjustable wire loop 42 within the knot configuration 50. The adjustable wire loop 42 is comprised of a pull side 40 with which, while the wire positioning and safety lanyard 10 is in use, a worker can either shorten or lengthen the adjustable wire loop 42, and resultantly the wire positioning and safety lanyard 10, depending on the direction of pull. The side opposite the adjustable wire, pull side 40 is the adjustable wire, non-pull side 41. The pressure on the adjustable wire loop 42 within the knot configuration 50 provided by the pull tension from the fixed wire loop 32 keeps the adjustable wire loop 42 from sliding out of the knot configuration 50 altogether. While the wire positioning and safety lanyard 10 is in use, a constant tension is placed on the adjustable wire loop 42 and the fixed wire loop 32 of the knot configuration 50.

The knot configuration is also shown held in place by a crimped, no-slide wire holder 20 and a slidable wire holder 22. The crimped, no-slide wire holder 20 allows for no movement of the wires placed in it. It permanently locks those wires into place. The slidable wire holder 22 provides containment for the wire on each side of the adjustable wire loop 42. The slidable wire holder 22 does not crimp down on one of the wires, nor does it prevent movement of one of the wires.

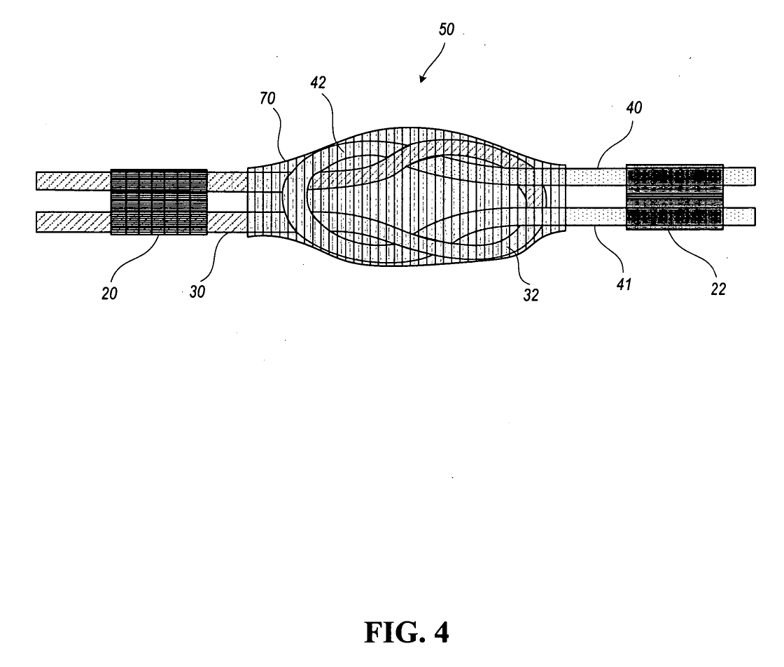

Referring now to FIG. 4, a front planar view of a knot configuration 50 is shown. The knot configuration 50 is shown with a knot configuration outer covering 70. The knot configuration outer covering 70 serves as a sleeve for the knot configuration 50, thus providing additional protection to the wires comprising the fixed wire loop 32 and the adjustable wire loop 42. The fixed wire 30 comprises the fixed wire loop 32. The adjustable wire, pull side 40 and the adjustable wire, non-pull side 41 comprise the adjustable wire loop 42. Additionally the knot configuration outer covering 70 aids in keeping the wires comprising the fixed wire loop 32 and the adjustable wire loop 42 free from dirt or debris that may be commonplace at a job site. By keeping these components clean, the knot configuration outer covering 70 also aids in the easy adjustability of the wire positioning and safety lanyard 10.

The knot configuration 50 is also shown held in place by a crimped, no-slide wire holder 20 and a slidable wire holder 22. The crimped, no-slide wire holder 20 allows for no movement of the wires placed in it. It permanently locks those wires into place. The slidable wire holder 22 provides containment for the wire on each side of the adjustable wire loop 42. The slidable wire holder 22 does not crimp down on the wires, nor does it prevent movement of the wires.

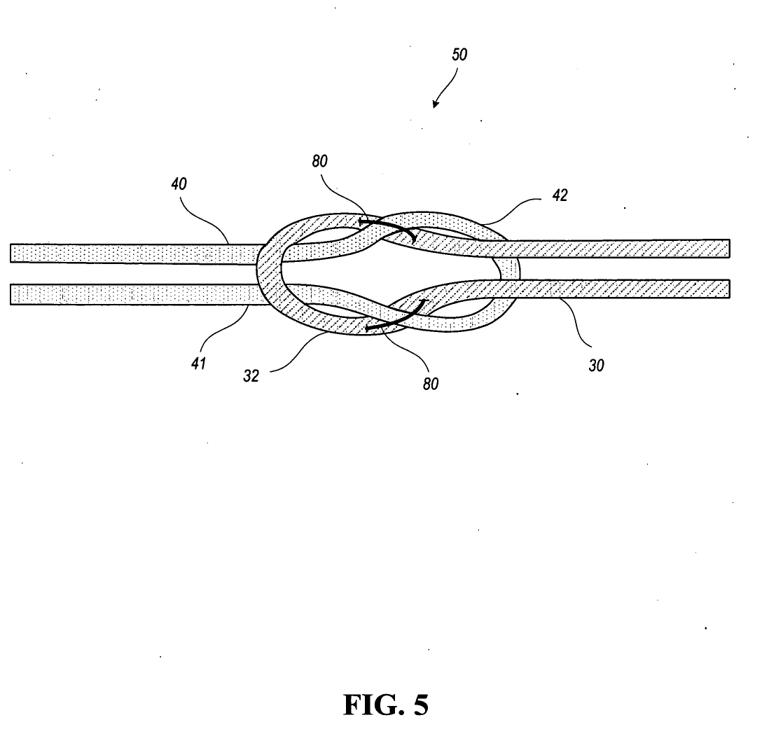

Referring now to FIG. 5, a front planar view of a knot configuration 50 is shown. Here an alternate configuration is shown such that the fixed wire loop 32 includes keeper loops 80. The keeper loops 80 are securely and permanently affixed to the fixed wire 30 which comprises the fixed wire loop 32 on which they are placed. The keeper loops 80 serve as both a guide to hold the adjustable wire loop 42 in place and to place additional tension in the knot configuration 50. The keeper loops 80 keep the knot configuration 50 from ever beginning to slack and to keep the wire loops remaining together. Additionally, the keeper loops 80 aid in maintaining the adjustable wire, pull side 40 and the adjustable wire, non-pull side 41 in place.

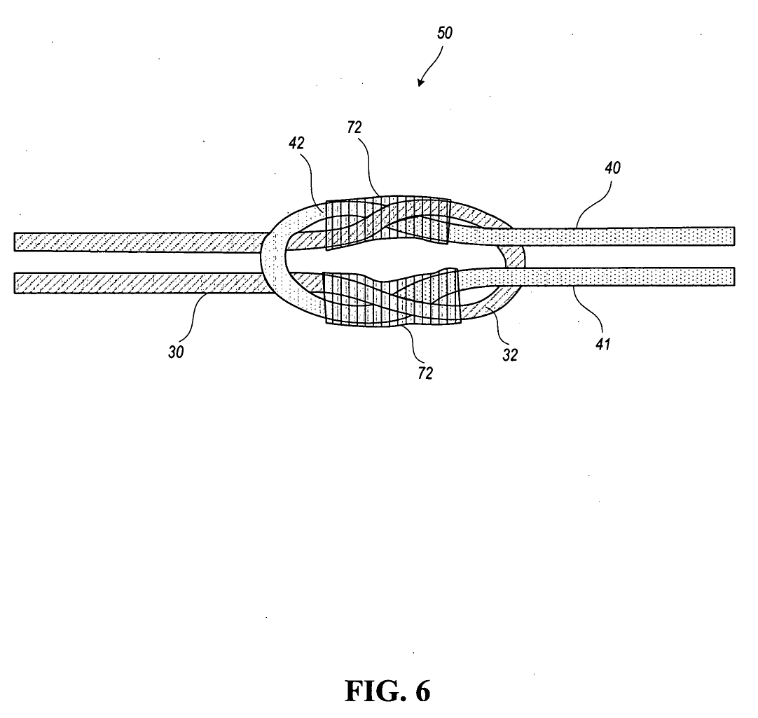

Referring now to FIG. 6, a front planar view of a knot configuration 50 is shown. Here an alternate configuration is shown such that the knot configuration 50 is comprised of a sheath 72 covering and protecting both the top and the bottom portions of the knot configuration 50. The fixed wire loop 32 and the adjustable wire loop 42 are covered at the two points where they cross in the knot configuration 50. The sheaths 72 serve as both a guide to hold the adjustable wire loop 42 in place and to place additional tension in the knot configuration 50. The sheaths 72 keep the knot configuration 50 from ever being to slack to keep the wire loops remaining together. Additionally, the sheaths 72 aid in maintaining the adjustable wire, pull side 40 and the adjustable wire, non-pull side 41 in place together with the fixed wire 30.

Although the present invention has been illustrated and described with reference to preferred embodiments and examples thereof, it will be readily apparent to those of ordinary skill in the art that other embodiments and examples may perform similar functions and/or achieve similar results. All such equivalent embodiments and examples are within the spirit and scope of the invention and are intended to be covered by the following claims.

What is claimed is:

1. A positioning and safety lanyard device for climbing, comprising:
a fixed loop, wherein the fixed loop is comprised of and formed by the looping of a fixed wire, wherein the fixed wire does not slide;
an adjustable loop, wherein the adjustable loop is comprised of and formed by the looping of an adjustable wire, the adjustable loop having a pull side with which, while the wire positioning and safety lanyard device is in use, to either shorten or lengthen the adjustable loop depending on the direction of pull;
at least one slidable wire holder, holding the adjustable wire comprising the adjustable loop;
at least one crimped, no-slide wire holder, holding the fixed wire comprising the fixed loop;
a knot configuration, with which the fixed loop and the adjustable loop are adjoined; and
two clasps, one located at each end of the positioning and safety lanyard device.

2. The positioning and safety lanyard device of claim 1, wherein the fixed loop is further comprised of a keeper loop on each side of the knot configuration to hold the adjustable loop.

3. The positioning and safety lanyard device of claim 1, wherein the knot configuration is further comprised of an outer covering.

4. The positioning and safety lanyard device of claim 1, wherein knot configuration is further comprised of a sheath covering on the top and bottom of the knot configuration.

5. The positioning and safety lanyard device of claim 1, wherein the spring-loaded clasp is used to serve the functional purpose of the fixed loop, and the adjustable loop is looped through a hole of the clasp, providing one half of the knot configuration.

6. The positioning and safety lanyard device of claim 1, wherein the fixed loop and the adjustable loop are color coded such that each is a different color, providing ease of use and easy identification.

7. The positioning and safety lanyard device of claim 1, wherein the knot configuration is further comprised of a clip placed on the fixed loop and providing a cylindrical channel in which to place the adjustable loop and hold it in place securely while still allowing the adjustable loop to be pulled in either direction through the channel.

8. The positioning and safety lanyard device of claim 1, wherein the positioning and safety lanyard device is comprised of steel cable for the fixed loop, adjustable loop, and knot configuration.

9. The positioning and safety lanyard device of claim 1, wherein the positioning and safety lanyard device is comprised of steel cable for the fixed loop, adjustable loop, and knot configuration and is coated with a vinyl covering.

10. A positioning and safety lanyard device for climbing, comprising:
a fixed fabric loop, wherein the fixed fabric loop is comprised of and formed by the looping of a fixed fabric cord, wherein the fixed fabric cord does not slide;
an adjustable fabric loop, wherein the adjustable fabric loop is comprised of and formed by the looping of an adjustable fabric cord, the adjustable fabric loop having a pull side with which, while the positioning and safety lanyard is in use, to either shorten or lengthen the adjustable fabric loop depending on the direction of pull;
one or more slidable fabric holders, holding the adjustable fabric cord comprising the adjustable fabric loop;
one or more crimped, no-slide fabric holders, holding the fixed fabric cord comprising the fixed fabric loop;
a knot configuration, with which the fixed fabric loop and the adjustable fabric loop are adjoined; and
two clasps, one located at each end of the positioning and safety lanyard device.

11. The positioning and safety lanyard device of claim 10, wherein the positioning and safety lanyard device is further comprised of keeper loops sewn onto the fabric with which to hold the adjustable loop in place.

12. The positioning and safety lanyard device of claim 10, wherein the knot configuration is further comprised of an outer covering.

13. The positioning and safety lanyard device of claim 10, wherein knot configuration is further comprised of a sheath covering on the top and bottom of the knot configuration.

14. The positioning and safety lanyard device of claim 10, wherein the clasp is used to serve the functional purpose of the fixed fabric loop, and the adjustable fabric loop is looped through a hole of the clasp, providing one half of the knot configuration.

15. The positioning and safety lanyard device of claim 10, wherein the fixed fabric loop and the adjustable fabric loop are color coded such that each is a different color, providing ease of use and easy identification.

16. The positioning and safety lanyard device of claim 10, wherein the knot configuration is further comprised of a clip placed on the fixed fabric loop and providing a cylindrical channel in which to place the adjustable fabric loop and hold it in place securely while still allowing the adjustable fabric loop to be pulled in either direction through the channel.

17. The positioning and safety lanyard device of claim 10, wherein the positioning and safety lanyard device is comprised of a climbing rope for each of the fixed loop, adjustable loop, and knot configuration.
